(19) United States
(12) Patent Application Publication
(10) Pub. No.: US 2016/0140466 A1
(43) Pub. Date: May 19, 2016

(54) DIGITAL DATA SYSTEM FOR PROCESSING, MANAGING AND MONITORING OF RISK SOURCE DATA

(71) Applicants: Peter Sidebottom, Summit, NC (US); Michael Monaghan, Charlotte, NC (US); Sanjay Gupta, Cherry Hills Village, CO (US)

(72) Inventors: Peter Sidebottom, Summit, NC (US); Michael Monaghan, Charlotte, NC (US); Sanjay Gupta, Cherry Hills Village, CO (US)

(21) Appl. No.: 14/541,570

(22) Filed: Nov. 14, 2014

(51) Int. Cl. G06Q 10/06

(52) U.S. Cl. CPC G06Q 10/0635

(57) ABSTRACT

A method and system for triaging and monitoring a risk source based on risk categorization. The system comprising a risk management server comprising a risk triage module configured to identify a risk source, receive information associated with the risk source, determine a category risk of the risk source, probe an inherent risk of the risk source, and configure scorecard monitoring for the risk source. The system further comprises a communications interface communicatively coupled to one or more client devices.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The invention described herein generally relates to evaluating sources of service based on risk data, and in particular, by ascertaining service reliability of service providers based on service risk categorization and quality of service monitoring.

2. Description of the Related Art

Many businesses, companies, government entities, non-profit and non-governmental organizations, and international organizations increasingly rely on third parties as service and product providers for creating, running, operating, and maintaining business systems and operations. However, when an enterprise outsources business processes to an external vendor, sensitive data may be transmitted, stored and processed on both company and vendor networks. Preventing risk events at third-party service providers has always been a challenge, but now the stakes are far higher. Data breaches at vendors and other third-parties continue to have a high profile in the news. As a consequence of cyber attacks, data breaches, and service disruptions that result from any problems with the third parties, business can lose clients, lose entire business relationships, be subject to criminal prosecution, be subject to civil lawsuits, and their reputation towards clients and investors can be impacted. Moreover, businesses tend to have a large number of such third-party service providers for different products and services which further increases risk.

The Office of the Comptroller of the Currency (“OCC”) charters, regulates, and supervises all national banks and federal savings associations as well as federal branches and agencies of foreign banks. The OCC ensures that national banks and federal savings associations operate in a safe and sound manner and comply with applicable laws and regulations. The OCC participates in interagency activities in order to maintain the integrity of the national banking system. By monitoring asset quality, management, information technology, and consumer compliance, the OCC is able to determine whether or not the bank is operating safely and soundly, and meeting all regulatory requirements. Responsibility of compliance with the OCC and anti-fraud typically rests with a compliance officer, Chief Risk Officer (“CRO”) or Chief Financial Officer (“CFO”). The compliance officer or CFO performs, or more typically, has one of his or her subordinates perform, various simplistic automated and manual processes in an effort to identify potentially fraudulent service providers.

Solutions exist that detect fraud and safeguard the integrity of day-to-day operations when interfacing with third party service providers. However, most conventional solutions fail to take into account various risk-related and service provider-specific databases and information sources that provide useful information to estimate certain risk that are typical for different categories of third-party service providers. Additionally, these solutions fail to maintain an accurate and complete inventory of service providers, incorporate sub third-party relationships into risk models, and establish operational risk methodologies and policies. There is thus a need for a service provider risk management system that provides comprehensive service categorization, rating and risk data collection.

### SUMMARY OF THE INVENTION

A method and system for triaging and monitoring a risk source based on risk categorization. The system comprising a risk management server comprising a risk triage module configured to identify a risk source, receive information associated with the risk source, determine a category risk of the risk source, probe an inherent risk of the risk source, and configure scorecard monitoring for the risk source, and a communications interface communicatively coupled to one or more client devices.

In one embodiment, the risk source originates from a service provider. According to another embodiment, the risk triage module is operable to determine the risk source has a category risk that is high. The risk triage module may also be operable to determine the risk source has an inherent risk that is high. In certain embodiments, the scorecard monitoring is configured for at least one of weekly and monthly monitoring. In yet another embodiment, the risk triage module is operable to generate notification messages associated with the scorecard monitoring.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a computing system according to an embodiment of the present invention;

FIG. 2 illustrates a risk management system according to one embodiment of the present invention;

FIG. 3 illustrates an exemplary dashboard interface for a business executive mode according to an embodiment of the present invention;

FIG. 4 illustrates an exemplary report of high risk vendors for particular categories of service according to an embodiment of the present invention;

FIG. 5 illustrates an exemplary report of medium risk vendors for particular categories of service according to an embodiment of the present invention;

FIG. 6 illustrates an exemplary report of risk according to various service categories according to an embodiment of the present invention;

FIG. 7 illustrates an exemplary report of risk associated with each business unit according to an embodiment of the present invention;

FIG. 8 illustrates an exemplary report of parent risk or risk of vendors for an umbrella of services that they provide according to an embodiment of the present invention;

FIG. 9 illustrates an exemplary search prompt according to an embodiment of the present invention;

FIGS. 10A, 10B and 10C illustrate an exemplary service provider performance report according to an embodiment of the present invention;

FIG. 11 illustrates a method for creating risk monitoring workflows for risk sources according to one embodiment of the present invention;

FIG. 12 through FIG. 19 illustrate exemplary questionnaire sections according to an embodiment of the present invention;

FIG. 20 illustrates an exemplary dashboard interface for a category manager or supply chain leader according to an embodiment of the present invention;

FIG. 21 through FIG. 26 illustrate various categories of information for scorecard outline creation according to an embodiment of the present invention;

FIG. 27 illustrates a scorecard outline notification according to an embodiment of the present invention;

FIG. 28 illustrates a notification message prompt according to an embodiment of the present invention;

FIG. 29 illustrate an exemplary dashboard interface for a vendor manager according to an embodiment of the present invention;

FIG. 30 through FIG. 37 illustrate exemplary performance metric configurations for setting up a performance scorecard according to an embodiment of the present invention;

FIG. 38 illustrates configurations for thresholds of key performance metrics and performance monitoring associated with setting up a performance scorecard according to an embodiment of the present invention;

FIG. 39 illustrates a confirmation screen for successfully setting up a scorecard according to an embodiment of the present invention; and

FIG. 40 through 45 illustrate exemplary risk performance scorecards according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The present invention provides a system and method for ranking sources of risk based on service categorization and monitoring of high priority risk sources. The system is operable to determine a risk rating of a source of risk based on a risk rating of a source category of the source of risk. The system further arbitrates the risk source by additional evaluation or probing based on risk-determination criteria and establishes a monitoring workflow for high risk sources. Evaluation or probing includes comprehensive checks and determinations in the end-to-end delivery of data, service, or products. The checks and determinations may be based on criteria such as technology, reliability, quality, security, etc.

Third party relationships are used by organizations, such as banks, to provide particular products or services of strategic or operational importance. Embodiments of the risk management system described herein are capable of providing organizations with real-time predictive analysis of their critical service providers, sub-service providers, their performance, and points of potential failure. Accordingly, the companies may assess the historical, current, or predicted risk associated with the data, service, and product exchanged or provided by third party service providers in accordance with a company's own risk management, security, privacy, and other consumer protection policies. The risk management system may also map known risk items into a standard risk framework, such as a risk management framework specified by the OCC or by other major industry risk organizations such as the inherent and residual risk framework from the Risk Management Association (RMA). The risk assessment system may also be used as a tool for organizations and adapted as necessary to reflect specific circumstances and individual risk profiles of varying scale and complexity.

The risk management system can be used in a variety of specific industry situations. The risk management system may be used by, for example, banks and insurance companies within the financial services industry to comply with OCC regulatory guidelines and the banks' service provider management operational requirements. Risk sources stemming or originating from service providers can be any of the many outsourced third parties to the financial industry including, but not limited to, vendors, suppliers, recruiting firms, personnel management firms, information technology (IT) companies, auditors, accountants, public relations firms, advertising firms, etc. In another embodiment, healthcare providers may also use the risk management system to manage and assess risk associated with handling of medical patient records to comply with The Health Insurance Portability and Accountability Act of 1996 (HIPAA), where the risk sources may be from bill collectors, insurance companies, hospitals, claims adjusters, record keepers, etc. Other exemplary industries for which the risk management system may be used include pharmaceuticals, utilities, aerospace, etc.

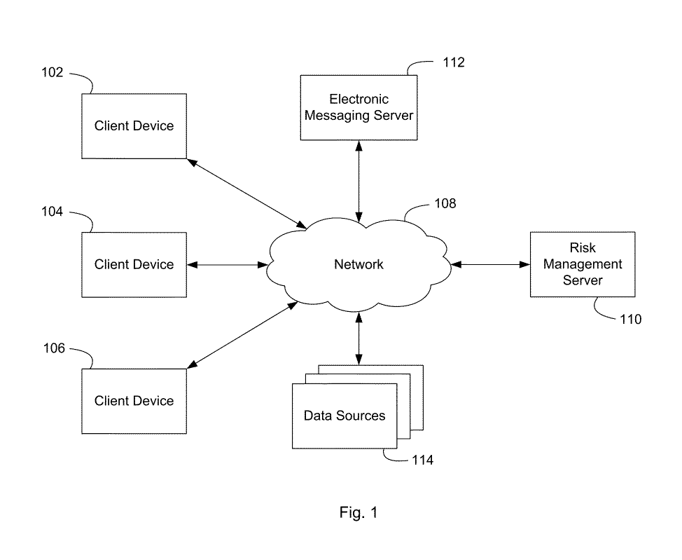

FIG. 1 presents a computing system according to an embodiment of the present invention. The system presented in FIG. 1 includes client device 102, client device 104, client device 106, network 108, risk management server 110, electronic messaging server 112, and data sources 114. Client devices 102, 104, and 106 may comprise computing devices (e.g., desktop computers, terminals, laptops, personal digital assistants (PDA), cell phones, smartphones, tablet computers, or any computing device having a central processing unit and memory unit capable of connecting to a network). Client devices may also comprise a graphical user interface (GUI) or a browser application provided on a display (e.g., monitor screen, LCD or LED display, projector, etc.). A client device may vary in terms of capabilities or features.

A client device may also include or execute an application to communicate content, such as, for example, textual content, multimedia content, or the like. A client device may include or execute a variety of operating systems, including a personal computer operating system, such as a Windows, Mac OS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples.

The risk management server 110 is operative to receive requests from client devices 102, 104, and 106 and process the requests to generate responses to the client devices across the network 108. According to one embodiment, the risk management server 110 may be a server owned, operated, managed, or maintained by the organization either on or off the premises of the organization (at a remote location) or hosted on a cloud. In another embodiment, client devices may have access to risk management server 110 by subscription (software as a service). Users of an organization may operate a given client device (102, 104, or 106) to access and utilize risk management server 110 to define, document and implement a risk source management program and view IT security information as well as other pertinent information regarding the organization's third party service providers.

Risk management server 110 is operable to identify levels of risk from various risk sources (e.g., service providers) and facilitate the creation of workflow(s) to monitor higher level risk sources. According to one embodiment, an organization's service provider portfolio may be screened through a categorization filter to triage risk sources to flag medium or high risk sources for further risk analysis. Levels of risk may be based on a pre-defined set of service categories and sub-categories that are scored as, for example, low, medium, and high risk based on various factors (developed from industry experience or as specified by the organization). One such factor may be the information to which a service provider has access to. For example, each service provider could be assessed pursuant to the highest level of client or corporate information they possess, store or handle. If the information to which a service provider has access is high risk information of non-public information, such as an end user's address, bank account information, investment holding, etc., the service provider would be assessed as a source of high risk, requiring on-going monitoring. If the information to which the service provider has access is low risk information, such as name, phone number, etc., the service provider would be assessed as a source of low risk. The procedures and workflow required would be lessened in comparison to the high-risk sources. The levels of risk can be established in a service provider database along with their risk profiles and/or security information. The database may further include information relating to service provider contract agreements, SAS70 reports, information security policies, incident response policies, business plans, insurance coverages, third party service provider management policies and programs and/or annual financial reports, as well as other pertinent information.

Electronic messaging server 112 may be a server facilitating communications via email, text message, instant message, SMTP, etc. accessible by client devices 102, 104, and 106. Risk management server 110 may send messages to individuals of an organization via the electronic messaging server 112. Data sources 114 may be content provider, social media, data aggregator, data retrieval and storage servers that are communicatively connected to risk management server 110 over network 108. Risk management server 110 may use data from the data sources 114 to provide additional data for risk assessment and/or reporting.

Servers, as described herein, may vary widely in configuration or capabilities but are comprised of at least a special-purpose digital computing device including at least one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Network 108 may be any suitable type of network allowing transport of data communications across thereof. The network 108 may couple devices so that communications may be exchanged, such as between a server and a client device or other types of devices, including between wireless devices coupled via a wireless network, for example. A network may also include mass storage, such as network attached storage (NAS), a storage area network (SAN), cloud computing and storage, or other forms of computer or machine readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof. Communications and content stored and/or transmitted to and from client devices may be encrypted using the Advanced Encryption Standard (AES) with a 256-bit key size, or any other encryption standard known in the art.

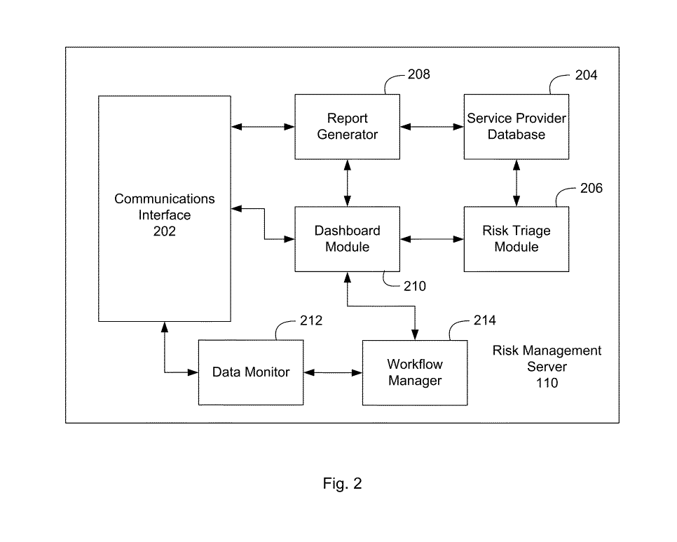

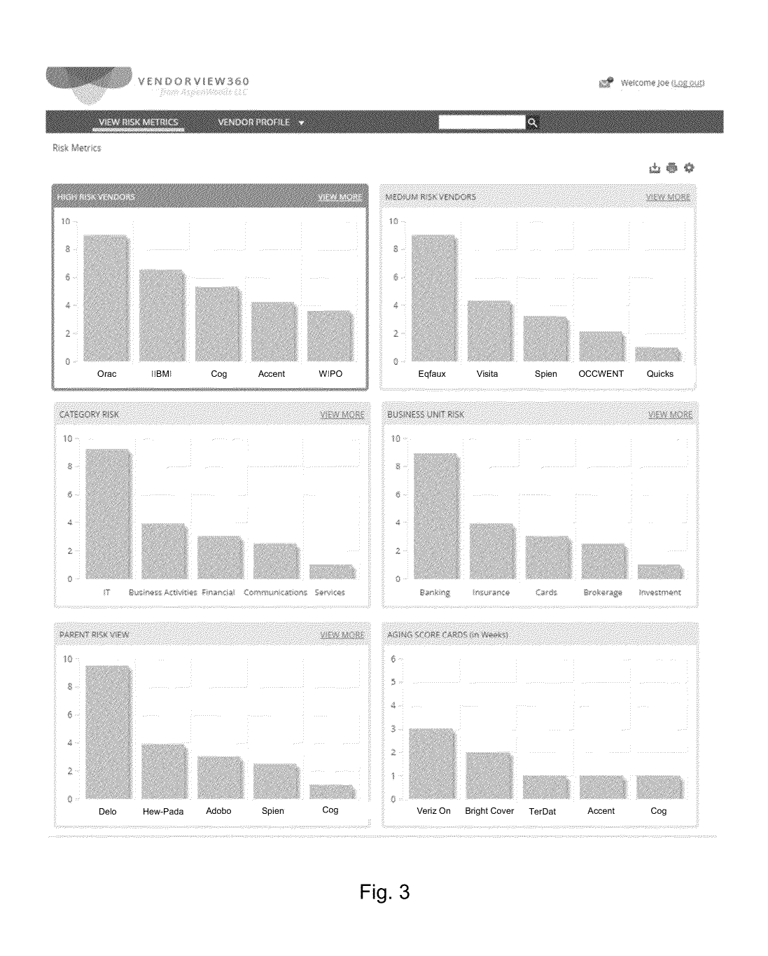

FIG. 2 presents a risk management system according to one embodiment of the present invention. The system comprises a risk management server 110 comprises communications interface 202, service provider database 204, risk triage module 206, report generator 208, dashboard module 210, data monitor 212, and workflow manager 214. Service provider database 204 comprises data, tables, and records representative of a portfolio or a list of service providers maintained by the organization. The service provider database 204 may also be configured as a data warehouse that maintains up-to-date versions of questions and answers/documents related to frequently asked questions about various service providers, which may be used in evaluating new relationships with service providers. Updates to the answers/documents may alert the organization to recalibrate its risk exposure to a service provider based on the updated answers/documents. According to alternative embodiments, service provider database 204 may be embodied as one or more devices or as cloud storage that are external to risk management server 110. The service provider database 204 is configured to provide service provider information and data to report generator 208 and risk triage module 206. Report generator 208 is operable to generate reports of service provider risk according to various criteria such as for medium risk vendors, high risk vendors, service category risk, business unit risk, and parent (company) risk. Reports generated by report generator 208 may be provided to the client devices via a webpage interface as illustrated in FIG. 3 through FIG. 10C.

According to one embodiment, report generator 208 may retrieve data from the data sources 114 via communications interface 202 for supplementing risk assessment and/or reporting. Data sources 114 may include news outlets, social media websites (e.g., Twitter, Facebook), blogs, etc. External data feeds or linkages (from data sources 114) can be monitored and retrieved for publicly listed service providers and presented in service provider reports to provide a comprehensive view on the risk trends and key external events (e.g., major changes in stock price and key news developments) related to the service provider. Content of the external data feeds may include content such as news, rumors, bankruptcy, lawsuits, weather impacts, product or service reviews and ratings, etc., that are associated with a given service provider in a service provider report. According to another embodiment, data sources 114 may also include commercial data, analytics, credit and financial information, and other business content providers that provide various business information reports. Monitoring the data sources 114 allows for alerting to the organization when there could be a change to risk levels for specific service providers and to take action to address a potential risk increase.

The risk management system provides reports to users of an organization to allow the users to review risk ratings and profiles of a plurality of the organization's service providers. Reports generated by report generator 208 aid users in reviewing the risk information regarding service providers with whom the organization is considering a relationship. In an alternative embodiment, analytics of vendor risk can be synthesized and aggregated from across multiple sources or instances of risk server management server 110 operated by a plurality of organizations and provided to report generator 208. Relevant and relative risk ratings applied to service providers from different organizations may be collected and compared to provide benchmarks or alerts when a given organization's evaluation of a service provider's risk is inconsistent with risk ratings of the same service provider from other organizations in the industry. Analytics could include elements of geographic risk, concentration risk, supplier risk patterns, etc. In a further embodiment, evaluations, performance criteria and performance metric weightings may be aggregated from a plurality of organizations or risk server management servers and used for creating a pre-screening mechanism of vendors to identify highest risk issues and provide benchmarking strategies for mitigating those risks. Accordingly, insights into a wide variety of service providers and across multiple geographies can be gathered and offered to each individual organization for assessment of geo-political risk and concentration risk.

Various types of risk may be evaluated using the presently described system. According to one embodiment, risk management server 110 is operable to determine category risk, vendor risk, and residual risk of service providers. Category risk, as used herein, may refer to a risk based on a category or classification of a service provider or of the services provided by the service provider. Vendor risk, as used herein, may refer to a risk of a service provider based on industry related risk analysis (e.g., inherent risk). Residual risk, as used herein, may refer to a risk calculated as an inverse of performance against key parameters in risk/performance scorecarding. That is, the higher the score on a scorecard, the lower the residual risk and vice versa.

Risk triage module 206 includes category assessment taxonomy logic for identifying a subset of risk sources such as medium and high risk service providers. The category assessment taxonomy logic is configured to assign category risk ratings to services providers based on service provider category, subcategory, and service type. One or more lists of service providers can be passed through the risk triage module 206 to filter service provider category risk through the dashboard module 210. The list of service providers may be imported into the dashboard module by means of a file, data capture, or data extraction from a client device, data source, corporate server, etc., and stored to service provider database 204. The dashboard module 210 is capable of transforming raw data or business data into appropriate data elements usable by one or more elements comprised in the risk management server 110. A subset of service providers may be identified in a filtering process and prioritized for further triaging or due diligence assessments (e.g., to determine inherent risk rating) that may be performed by risk triage module 206. The results of these assessments can help establish the appropriate monitoring and control requirements that should be maintained for each service provider.

For example, a scorecarding workflow may be created for service providers identified as high risk sources using workflow manager 214. A supply chain leader of the organization may configure and assign scorecarding workflows to a service provider manager(s) of the organization. A scorecarding workflow includes a series of evaluations of a plurality of performance criteria based on qualitative and quantitative metrics. Each performance criteria may be assigned a given weighting for calculating an overall scorecard rating of the service provider. The evaluations may be performed automatically, manually or a combination of both and on a periodic basis (e.g., daily, weekly or monthly). Risk performance criteria may include, but are not limited to, technology, quality, support, delivery, business, and economic. Certain metrics for the risk performance criteria may evaluate type and usage of technology, proper usage of technology, system integrity, maintenance and upgrade of technology, speed, performance quality, service consistency, regulatory and standards compliance.

Data monitor 212 monitors ongoing risk and quality of service of the service providers by examining the scorecarding workflows and determining the aging of scorecards. Increase aging of scorecards may present an increased risk resulting from outdated data (or a neglect in risk monitoring). The data monitor 212 may send reminder messages to the service provider managers of the organization at electronic messaging server 112 over network 108 via communications interface 202 to follow-up on the progress of scorecard evaluations. Risk information and scorecards may be electronically stored, modified, and updated in service provider database 204 for retrieval by report generator 208. Any changes made to the risk information, risk ratings, categories, ratings associated with each category, or scorecards may be logged in, for example, an audit trail for inspection by a manager, executive, regulator or auditor, etc. The triaging method described herein focuses resources on the service provider relationships that matter most, limiting unnecessary work for lower-risk relationships.

According to one embodiment, the risk management system may provide specific features according to different user modes. Risk management server 110 is configurable to provide several unique user personas in the user interface, dashboards, workflow and reporting. The unique personas provider tailored user experiences based on each specific user requirement. This includes specific workflows for a CRO/CFO, supply chain leader, business unit leader and service provider lead/manager. For example, a business executive user such as a CRO or CFO may only desire to be provided with risk reports on a high level view to identify the higher risk sources and summarize risk trends and underlying risk areas to address. Meanwhile, a category manager/business unit leader or supply chain leader users may be provided with functionality to create initial scorecard outlines and add new service providers to the service provider database. Furthermore, service provider manager users who interact with the service providers on a regular basis may be provided with scorecard setup and scorecard task functions. However, it should be noted that any of the features described herein are features that may be included in any one of the user modes.

FIG. 3 presents an exemplary dashboard interface for a business executive mode according to an embodiment of the present invention. The interface displays risk charts according by high risk vendors, medium risk vendors, category risk, business unit risk, parent risk, and aging score card risk. Each chart may be selected to access a report for further details.

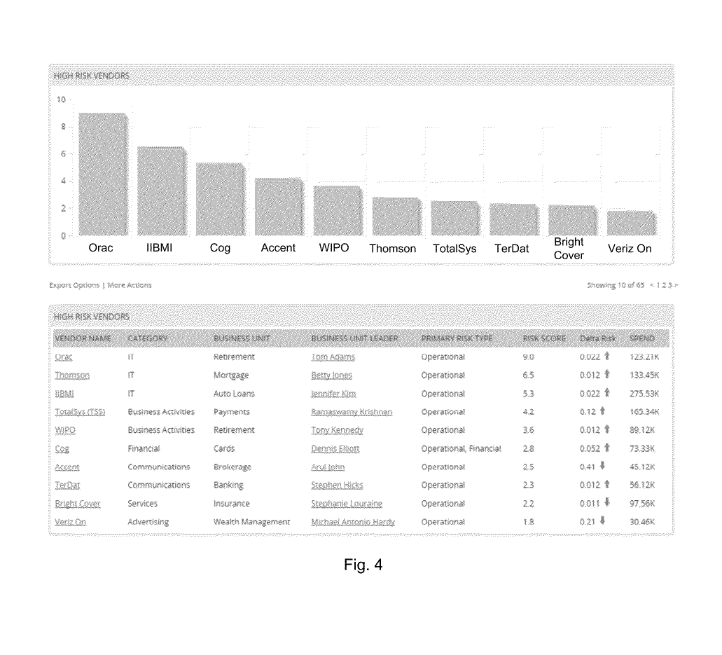

FIG. 4 presents an exemplary report of high risk vendors for particular categories of service according to an embodiment of the present invention. The report includes a bar chart of ratings associated with a plurality of vendors deemed as high risk vendors. The vendor name, category, business unit, business unit leader (service provider manager), primary risk type, risk score, delta risk, and spend are displayed for each of the high risk vendors.

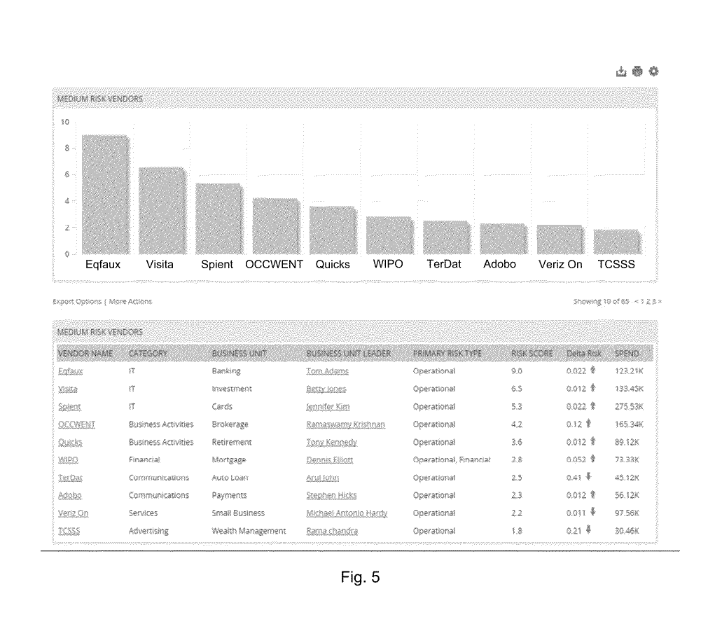

FIG. 5 presents an exemplary report of medium risk vendors for particular categories of service according to an embodiment of the present invention. The report includes a bar chart of ratings associated with a plurality of vendors deemed as medium risk vendors. The vendor name, category, business unit, business unit leader (service provider manager), primary risk type, risk score, delta risk, and spend are displayed for each of the medium risk vendors.

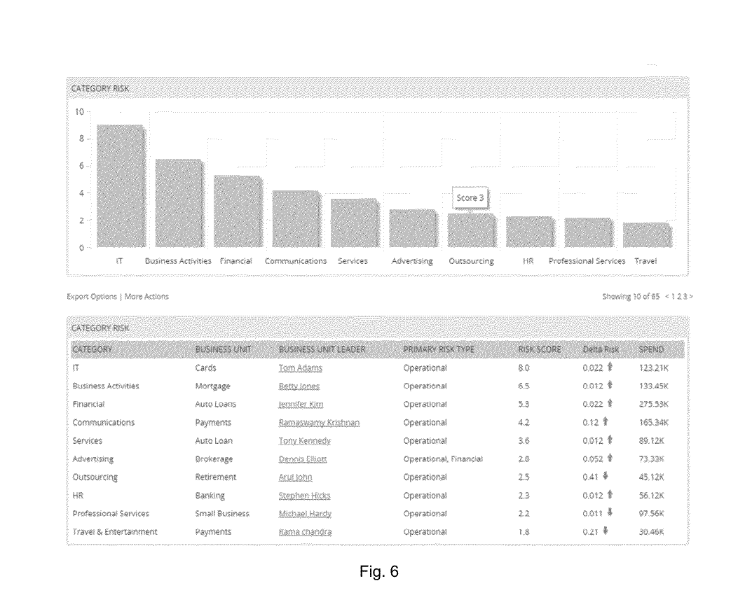

FIG. 6 presents an exemplary report of risk according to various service categories according to an embodiment of the present invention. The report includes a bar chart of risk ratings for a plurality of service categories. The category, business unit, business unit leader (service provider manager), primary risk type, risk score, delta risk, and spend are displayed for each of the service categories. Service categories may be predefined according to default settings or as specified by the organization.

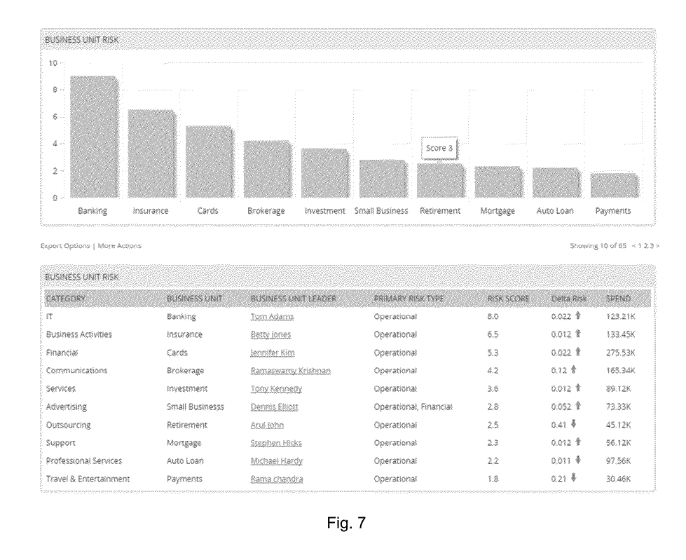

FIG. 7 presents an exemplary report of risk associated with each business unit according to an embodiment of the present invention. The report includes a bar chart of risk ratings for each business unit. The service category of the business unit, the business unit, business unit leader (service provider manager), primary risk type, risk score, delta risk, and spend are displayed for each of the business units. Business units may be predefined according to default settings or as specified by the organization.

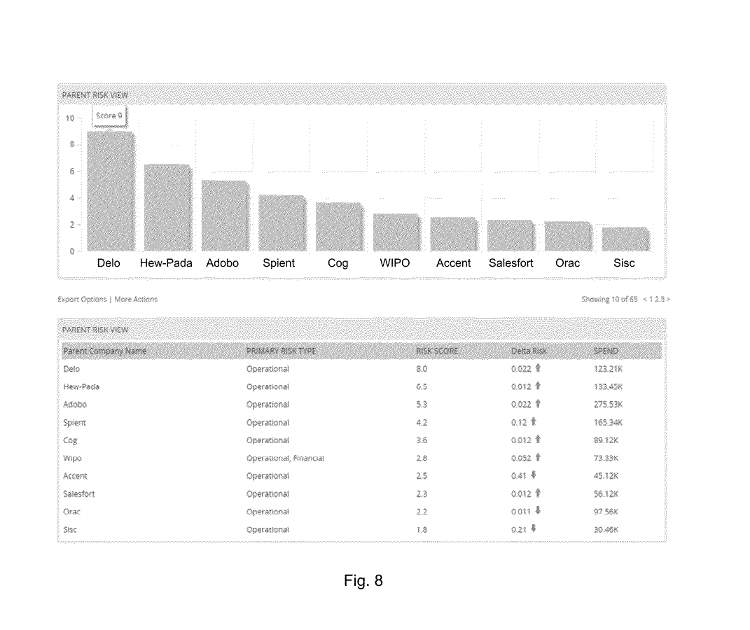

FIG. 8 presents an exemplary report of parent risk or risk of vendors for an umbrella of services that they provide according to an embodiment of the present invention. The report includes a bar chart of parent risk for a plurality of vendors. The parent company name, primary risk type, risk score, delta risk, and spend are displayed for each of the parent companies.

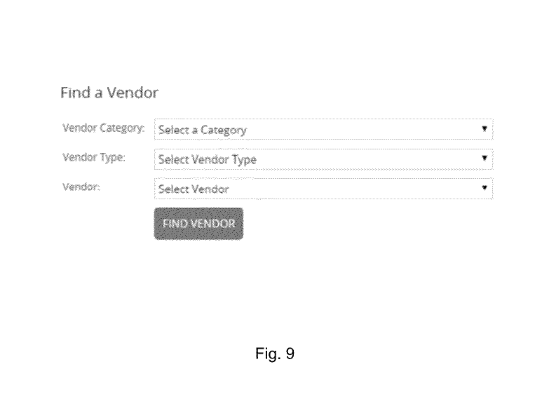

The risk management system further allows a user to search for and view performance of service providers by any of a variety of criteria, such as by service provider, keyword, service category, service product type, and other methods that allow for users to locate a service provider. An exemplary search prompt is illustrated in FIG. 9. A user may enter one or more search criteria to locate the performance of a specific service provider.

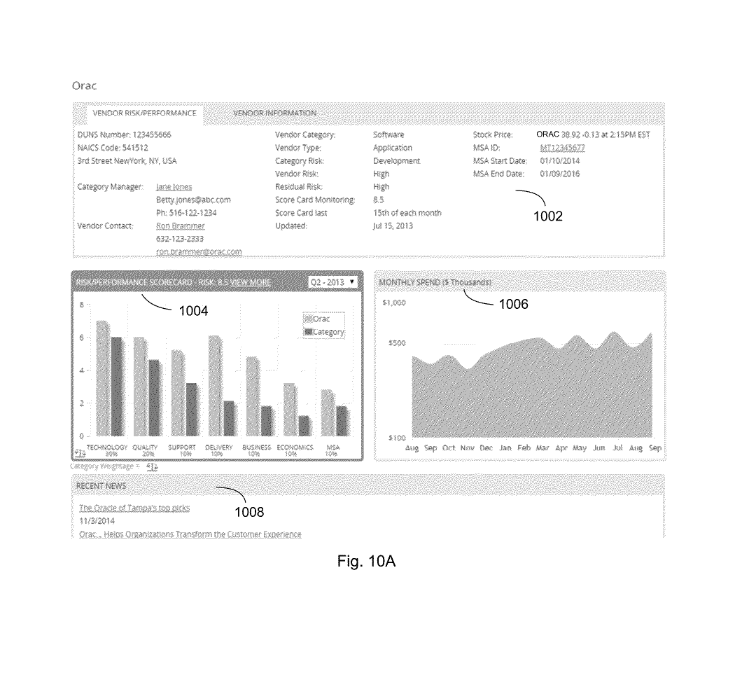

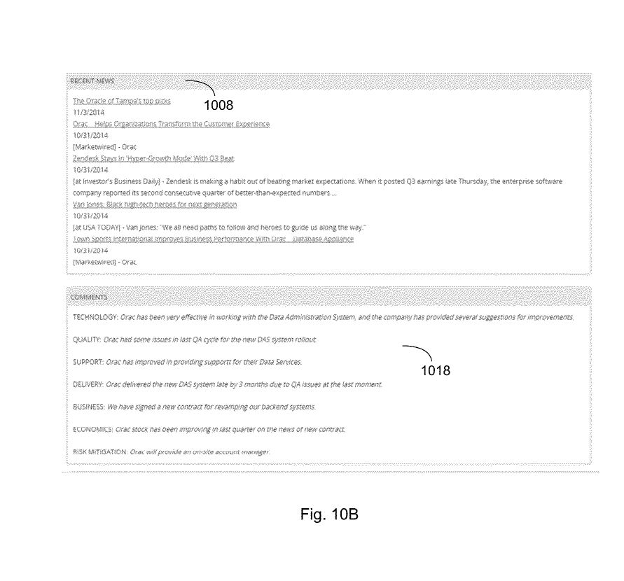

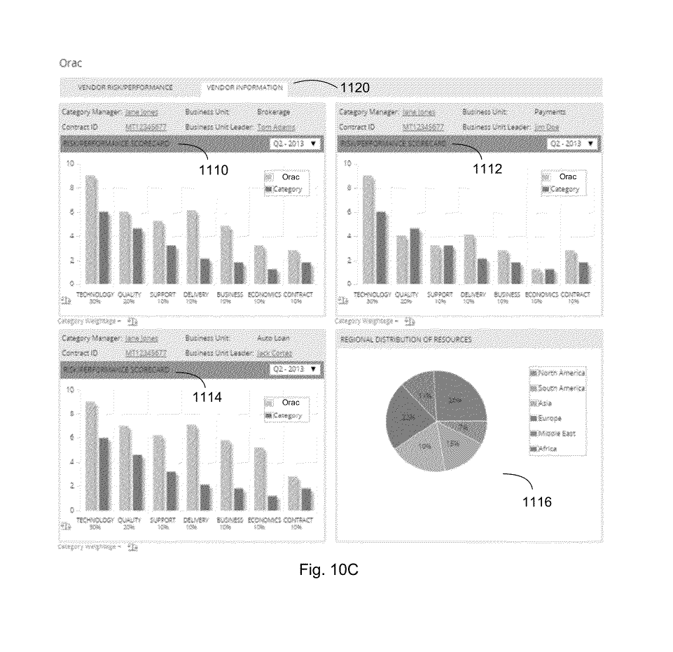

FIGS. 10A, 10B and 10C present an exemplary service provider performance report according to an embodiment of the present invention. The performance report illustrated in FIG. 10A presents a vendor risk/performance information tab 1002 including a vendor's address, category manager information, vendor contact information, vendor category, vendor type, category risk, vendor risk, residual risk, score card monitoring rating, date of last score card, date of when the score card was last updated, stock price of the vendor (retrieved from an external data source), a master service agreement (MSA) ID and link to a copy or abstract of the MSA, the start date and the end date of the MSA. Information such as the MSA and monthly spend information may be retrieved from within the organizations internal systems (e.g., accounting, operations). Each service provider risk scorecard is linkable to the MSA. Scorecards contain qualitative and quantitative measures to proactively determine ongoing risk for each service provider.

Risk/performance Scorecard bar chart 1004 provides scorecard evaluation ratings for the vendor compared to a vendor average in a variety of performance criteria for a given time period (e.g., fiscal quarter). Monthly spend chart 1006 presents the amount of money spent by the organization for services provided by the vendor. The performance report further includes recent news feed 1008 and comments 1018 extracted from the scorecards completed by the organization's service provider manager, as illustrated in FIG. 10A and FIG. 10B. In the illustrated example, the service provider is a publicly-listed company. Recent news feed 1008 may include any information retrievable from an external data source that provides news or any relevant information associated with the service provider that is publicly available.

The performance report further includes a vendor information tab 1020, illustrated in FIG. 10C. Vendor information tab 1020 includes risk/performance scorecard charts modules for a variety of business units. A plurality of the vendor's business units may be compared according to a variety of scorecard performance criteria. Risk/performance scorecard chart 1010 provides comparative scorecard ratings for the brokerage business unit of the vendor. Payments Risk/performance scorecard chart 1012 provides comparative scorecard ratings for the payments business unit of the vendor. Auto loans Risk/performance scorecard chart 1014 provides comparative scorecard ratings for the auto loan business unit of the vendor. Users may select to view risk/performance scorecard data for a plurality of fiscal quarters on vendor information tab 1020 on each chart module. Pie chart 1016 of regional distribution of the vendor's resources, which may be useful for evaluating risk.

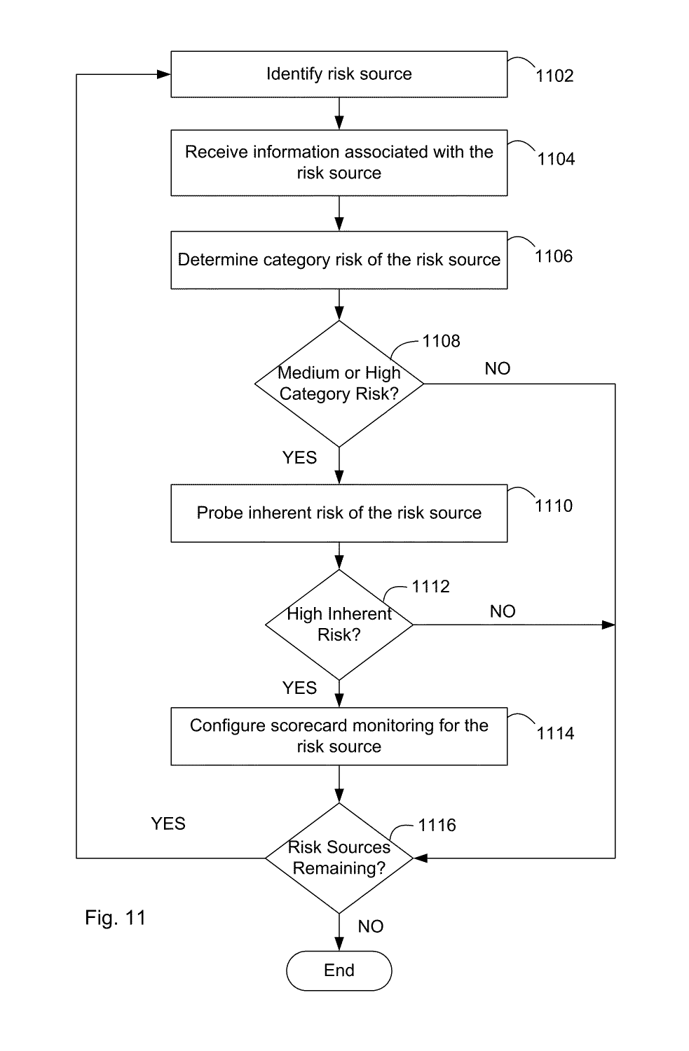

FIG. 11 presents a method for creating risk monitoring workflows for risk sources according to one embodiment of the present invention. The following method steps may be performed by a risk triage module or any combination of elements within a risk management server. An organization's service provider portfolio can be passed through a service provider category risk filtering process to triage the organization's service providers into medium and high risk candidates for further analysis. The service provider portfolio may comprise digital data files received or extracted by the risk management system via a dashboard module. The digital data files including digital data that may be embodied in at least one of data tables, spreadsheets, or data structures containing structured or unstructured data. Service providers may be enumerated in a list in the digital data files enabling the system to extract each service provider and any associated information such as service provider address, contact information, vendor manager, and MSA information.

A risk source is identified, step 1102, from the service provider portfolio. Identifying the risk source may include identifying a service provider from one or more digital data files of a service provider portfolio and generating a record for the service provider in a service provider database. Information associated with the risk source is received, step 1104. Corresponding information of the service provider may be extracted from the one or more digital data files of the service provider portfolio or received from manual entry to populate one or more fields of the generated record. The one or more populated fields include at least one of service category, service sub-category, service type, or business unit.

Category risk of the risk source is determined, step 1106. The category risk is determined based on one or more of the service provider's service category and service sub-category. A defined set of scores (e.g., low, medium or high risk) may be assigned to specific service provider categories and sub-categories based developed industry experience/statistics or as specified by the organization. If the risk source does not have a category risk that is medium or high, step 1108, the method proceeds to step 1116 to determine if there are additional risk sources in the service provider portfolio, otherwise, the method ends.

Otherwise, the system detects that the risk source has a medium or high category risk. Medium and high category risk service providers are passed through further triaging based on inherent service provider risk. Inherent risk of the risk source is probed, step 1110. Service providers are probed based on a series of questions to ascertain each service provider's inherent risk rating. A given questionnaire for probing inherent risk includes key sections that are scored based on risk levels for each question. The questions may be industry-specific or as specified by the organization.

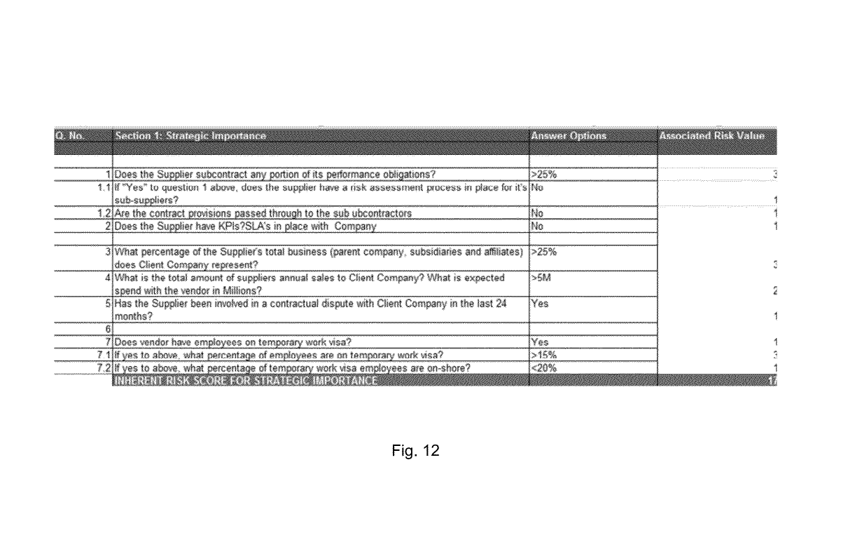

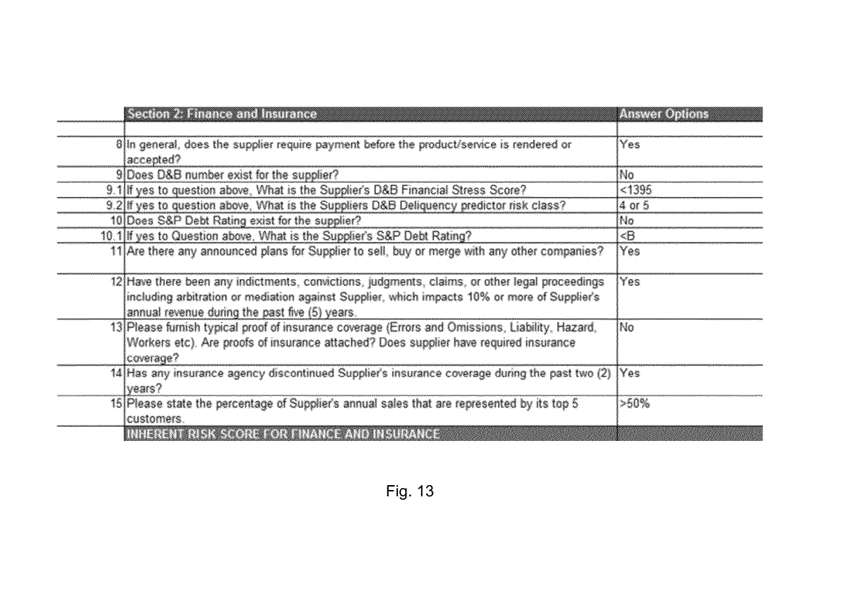

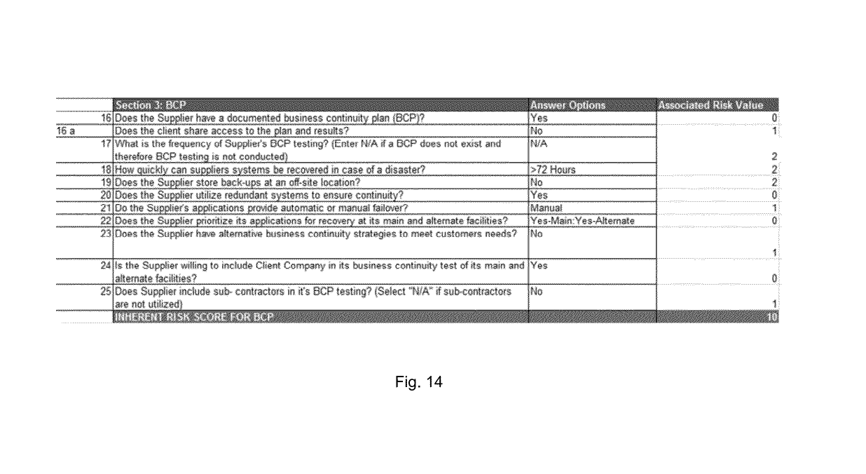

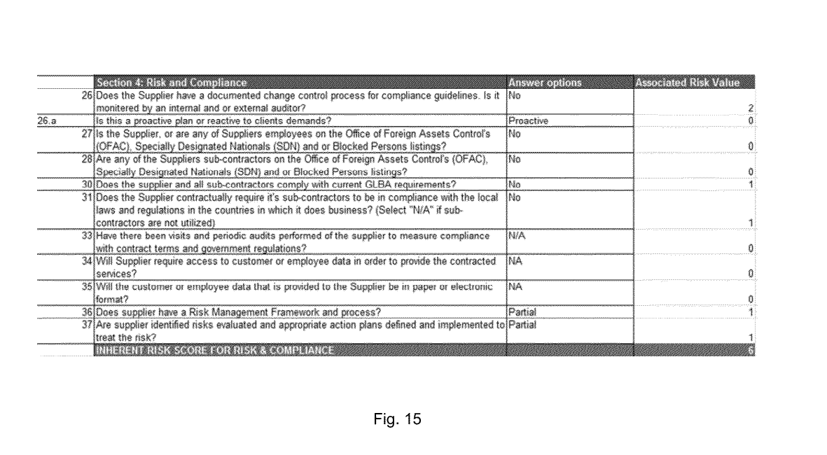

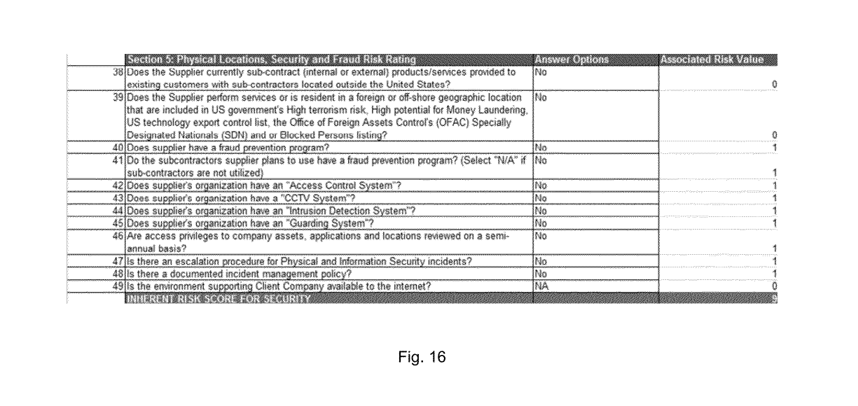

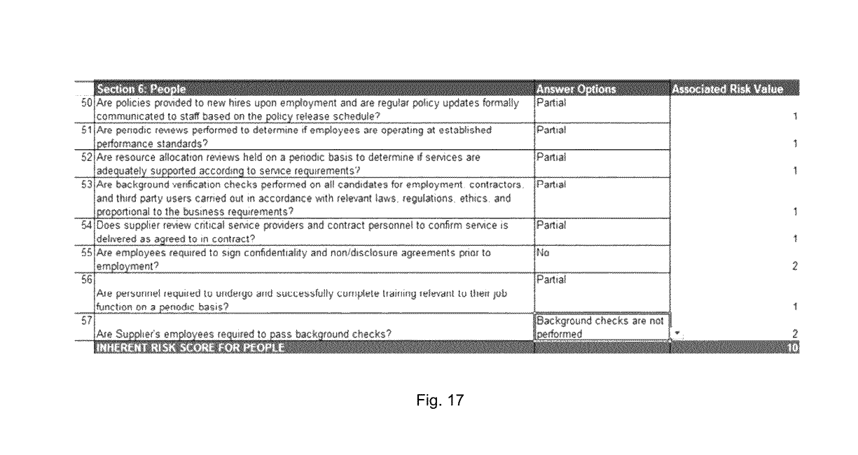

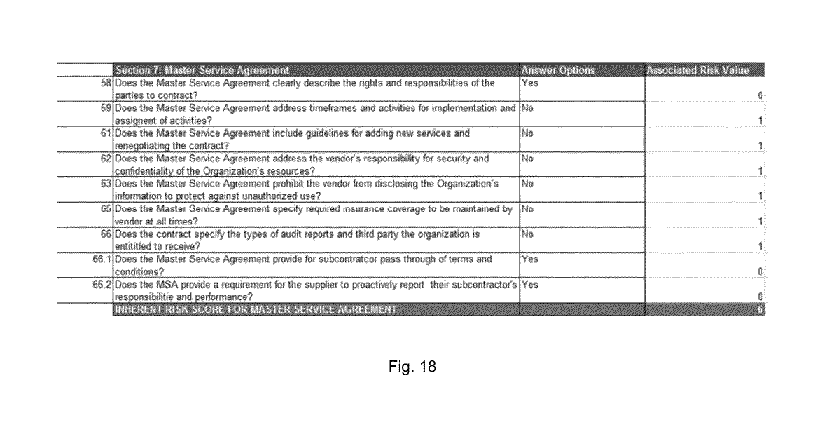

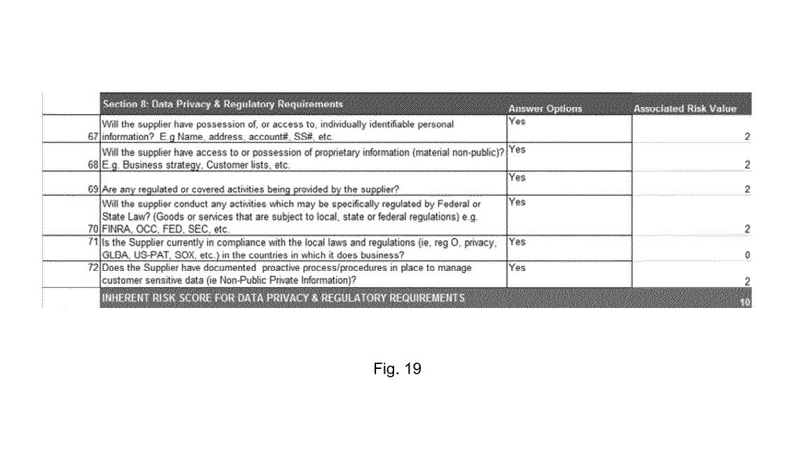

FIG. 12 through FIG. 19 present exemplary questionnaire sections based on strategic importance, finance and insurance, business continuity plan, risk and compliance, physical locations, security and fraud risk rating, people (staff), master service agreement, data privacy and regulatory requirements according to an embodiment of the present invention. Each questionnaire section includes a plurality of questions, answer options, and an associated risk value for each answer option. Inherent risk scores may be calculated for each questionnaire section. A final inherent risk score may be calculated by summing the inherent risk scores of all the questionnaire sections. The final inherent risk score can be used to determine an inherent risk of the service provider. According to the present example, a final inherent risk score in the range of 49 or below rates the service provider with a low inherent risk, a final inherent risk score in the range of 50 to 69 rates the service provider with a medium inherent risk, and a final inherent risk score in the range of 70 or above rates the service provider with a high inherent risk.

Referring back to FIG. 11, high inherent risk service providers are routed, step 1112, to a risk and performance scorecarding workflow configuration process while medium inherent risk service providers do not require additional monitoring. Scorecard monitoring for the risk source with high inherent risk is configured, step 1114. Configuring the scorecard monitoring includes creating an initial scorecard outline. Upon configuration of the scorecard monitoring, a workflow is created for on-going monitoring of the risk source. The method checks for whether there are risk sources remaining in the service provider portfolio, step 1116, otherwise, the method ends.

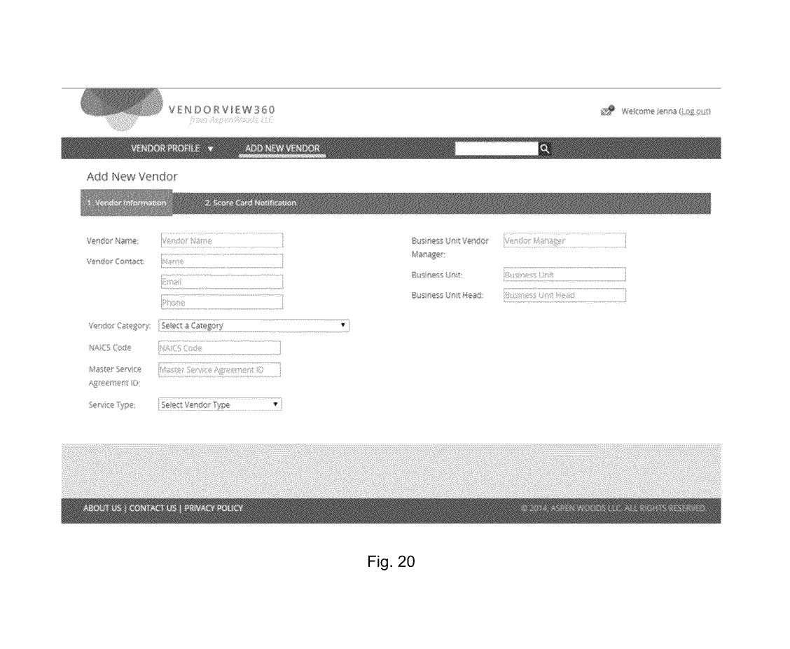

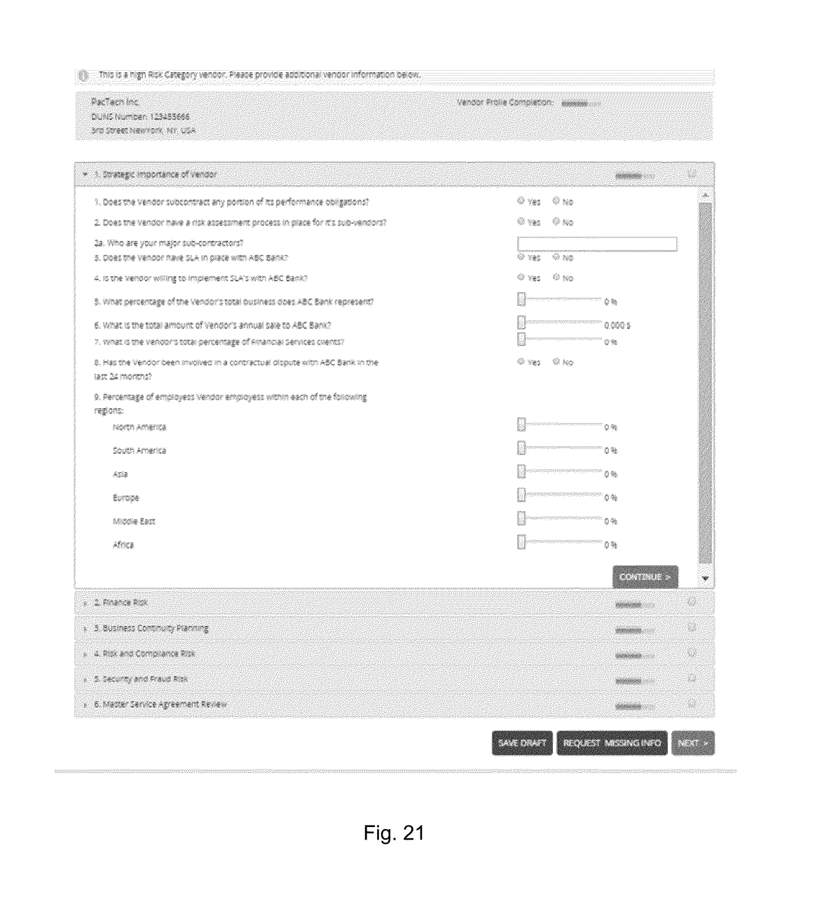

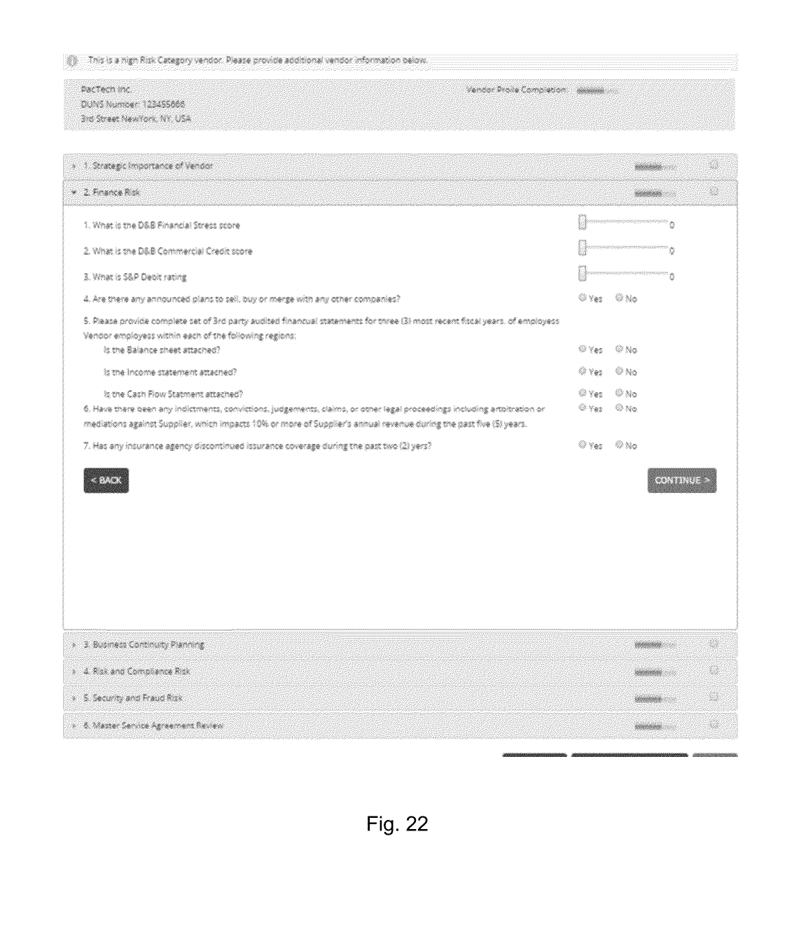

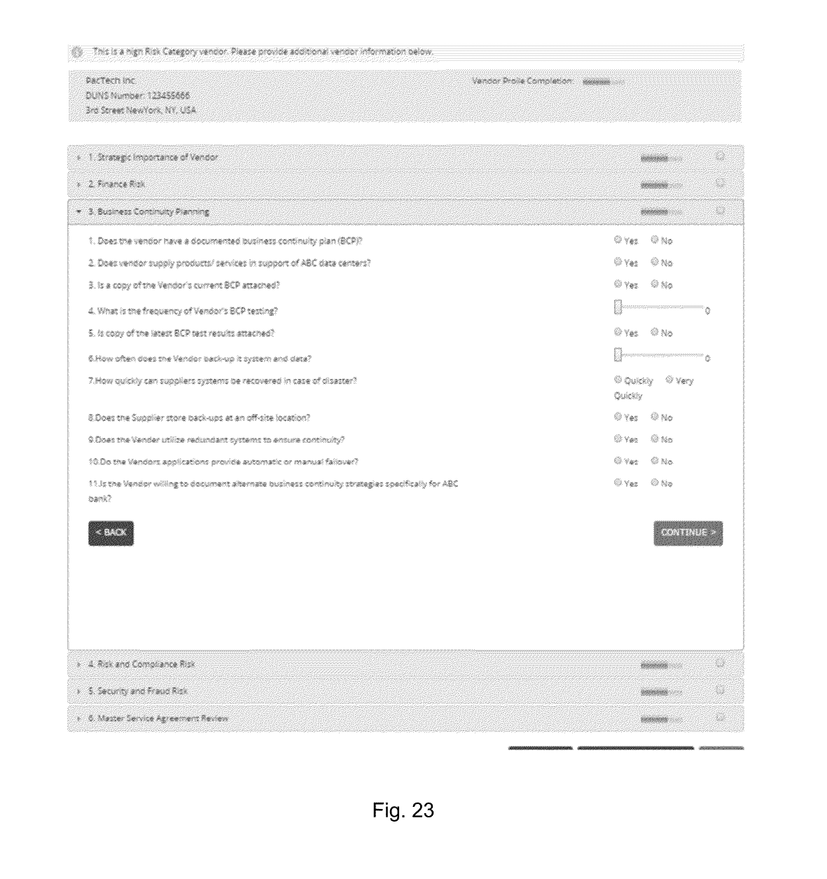

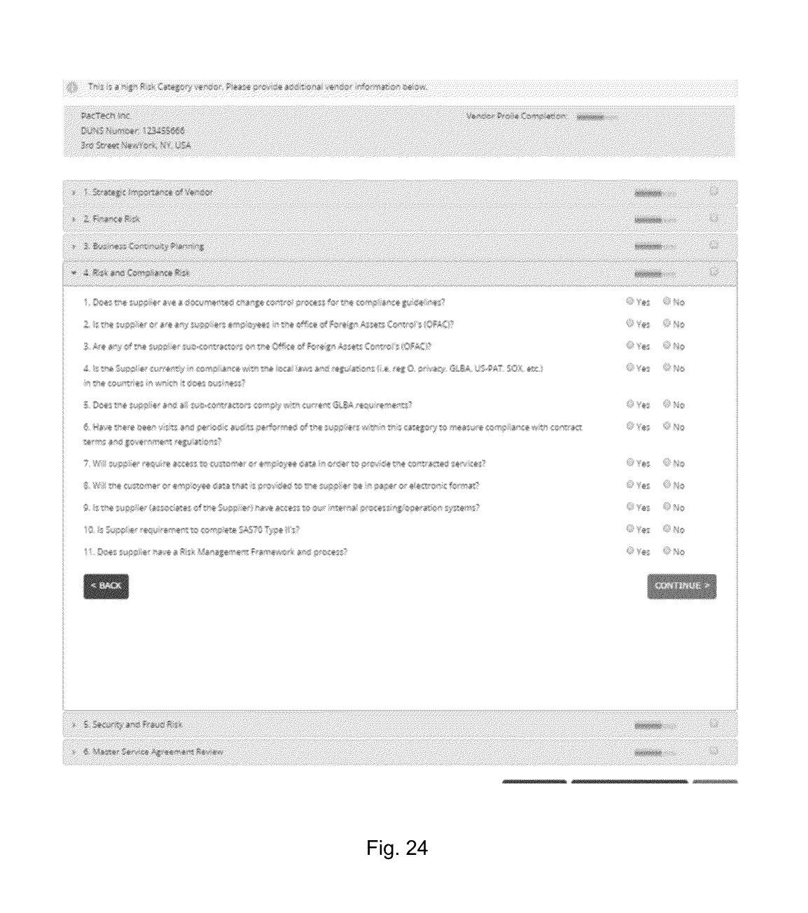

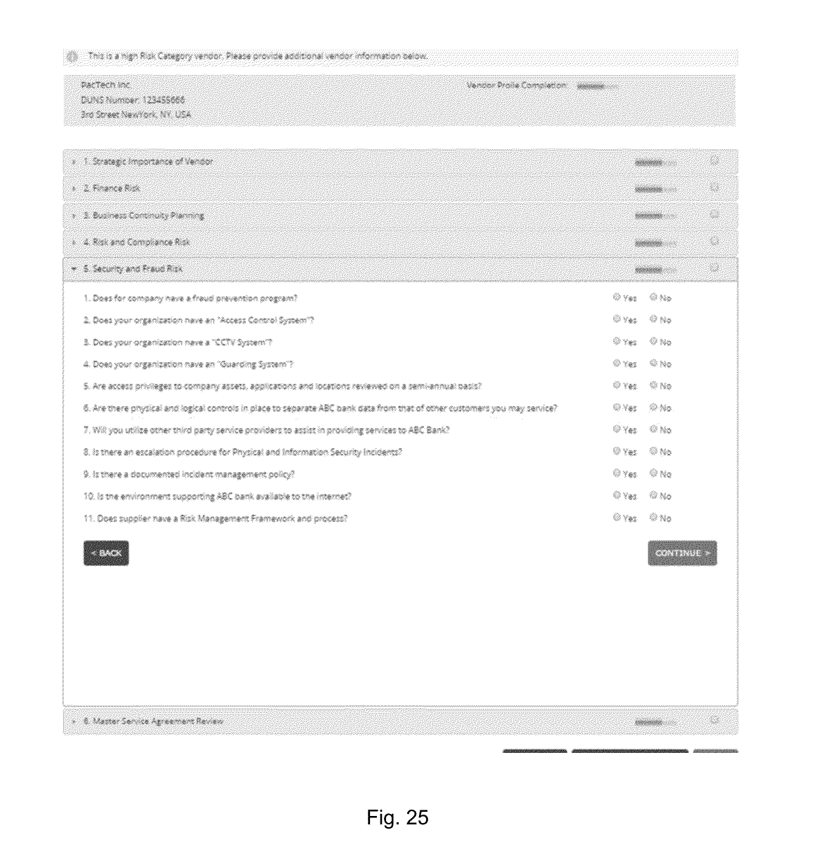

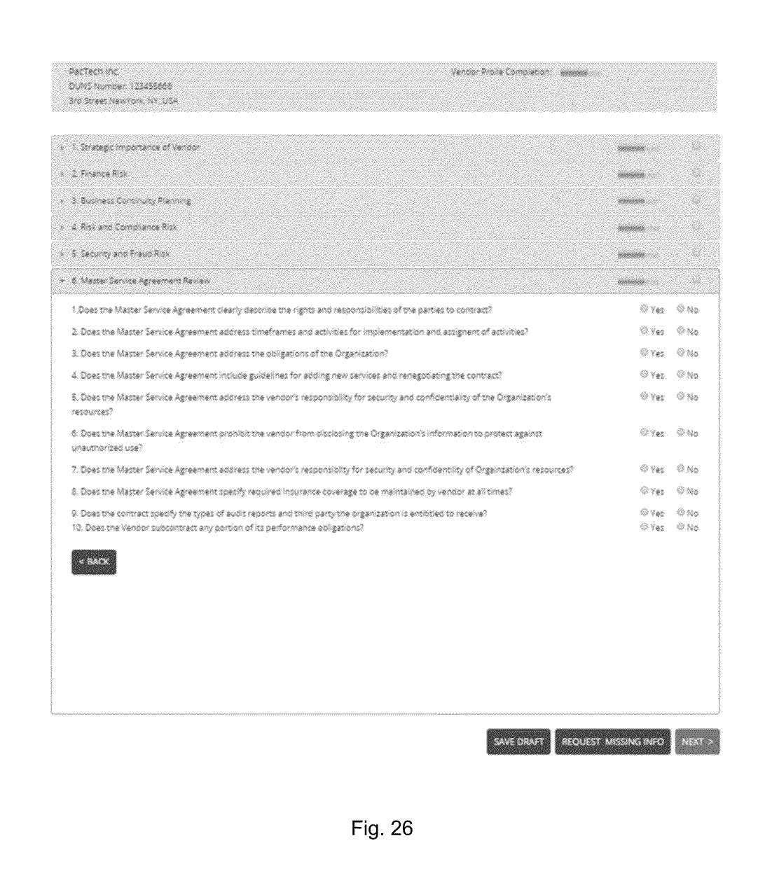

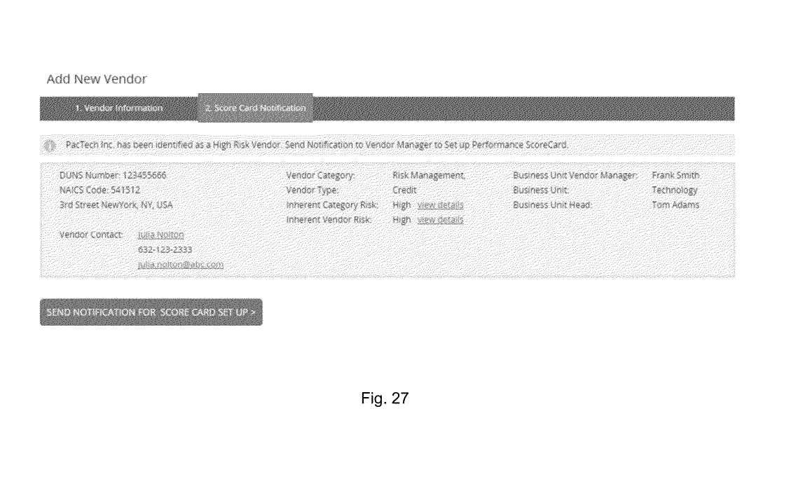

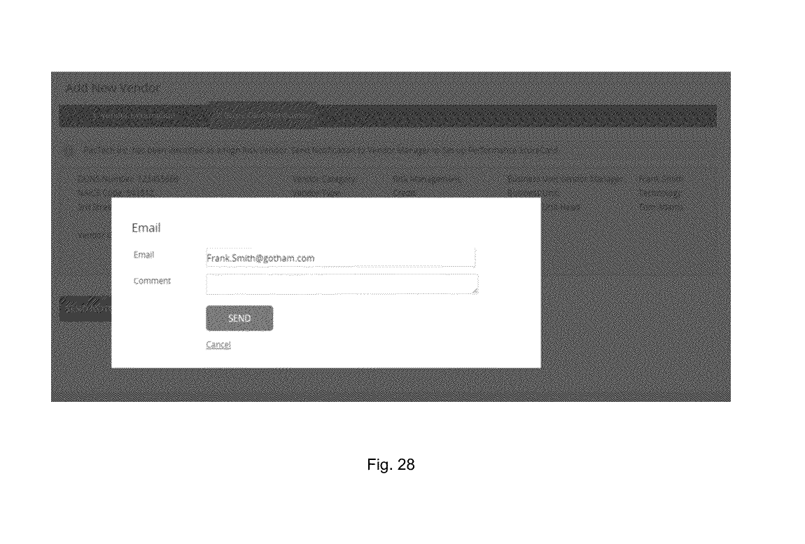

FIG. 20 presents an exemplary dashboard interface for a category manager or supply chain leader for creating scorecard outlines according to an embodiment of the present invention. An initial scorecard outline may be created by a user (category manager or supply chain leader). The category manager or supply chain leader may add a new vendor or import existing vendors with basic information through automated means. A high risk vendor, as determined by category risk, is identified by the system and prompts the user to enter information under various categories such as strategic importance of vendor, finance risk, business continuity planning, risk and compliance risk, security and fraud risk, and master service agreement review, as illustrated in FIG. 21 through FIG. 26. Upon completion of the scorecard outline, a confirmation may be generated (e.g., FIG. 27) and a notification to a vendor manager to set up the scorecard may be sent. According to the illustrated example in FIG. 28, the notification may be sent to the vendor manager via email or alternatively, any other electronic messaging service.

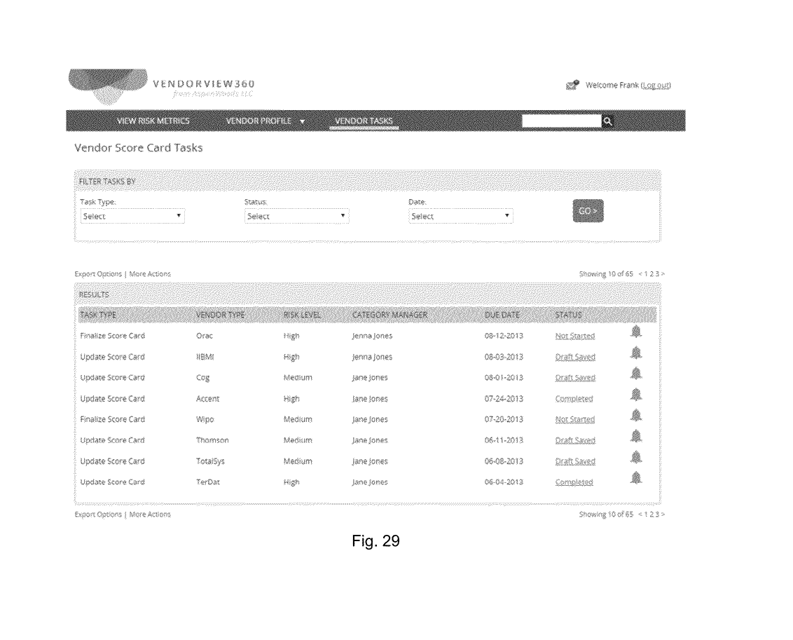

FIG. 29 presents an exemplary dashboard interface for a vendor manager according to an embodiment of the present invention. A user (vendor manager) may be presented with a plurality of vendor score card tasks to perform or complete. A performance scorecard is operable as a monitoring tool that evaluates a supplier based upon, for example, six (6) criteria areas: technology, quality, support, delivery, business, and economics. A vendor manager may be asked to distribute ‘100’ weight points among these six areas to calculate a service provider's final score. More points may be given to areas that are more important and less points may be given to those that are less important.

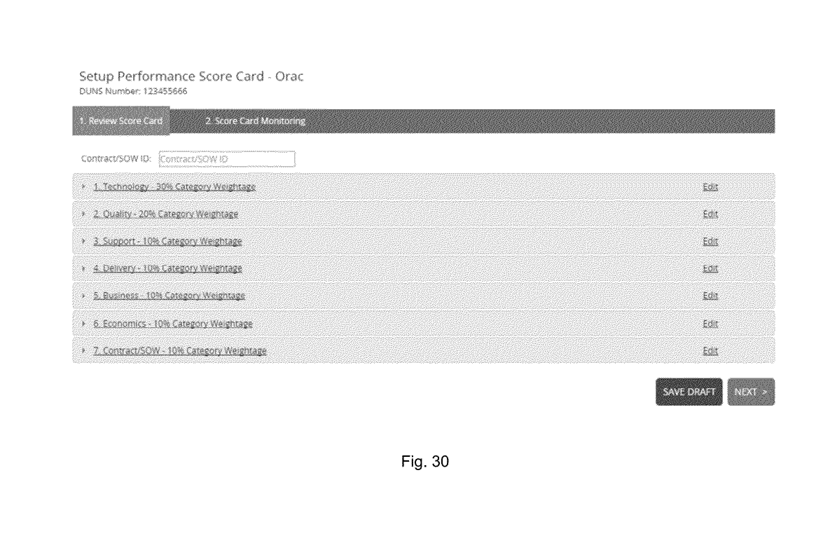

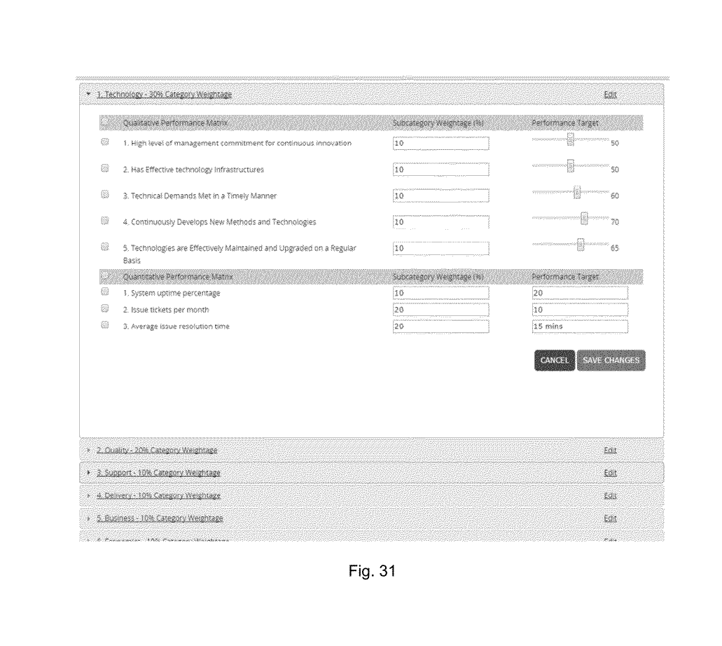

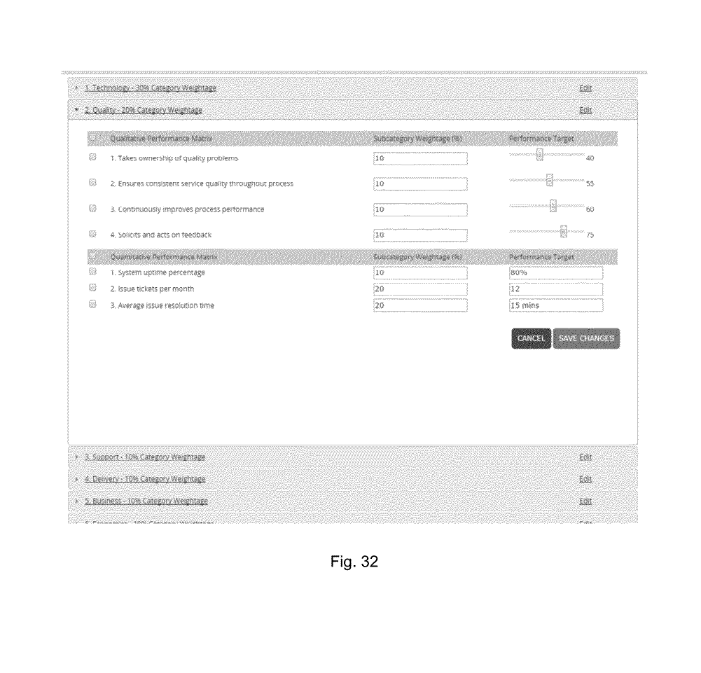

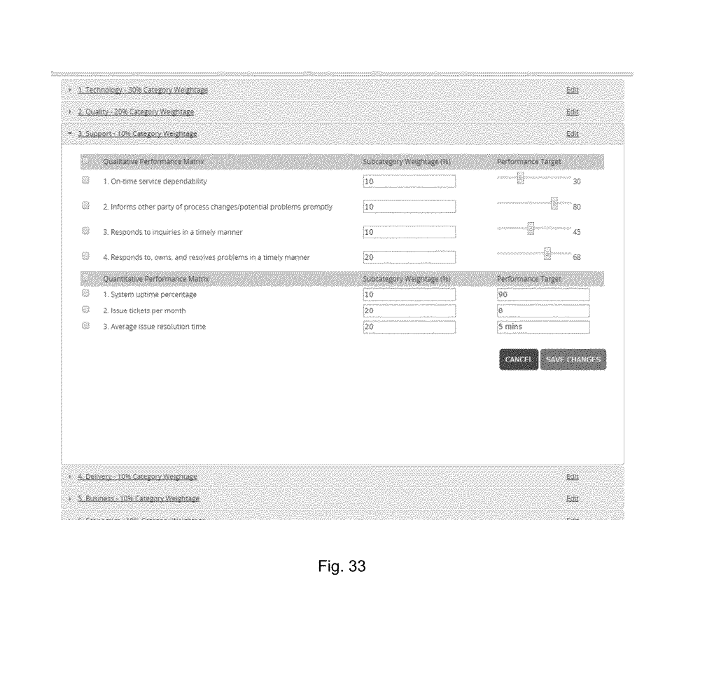

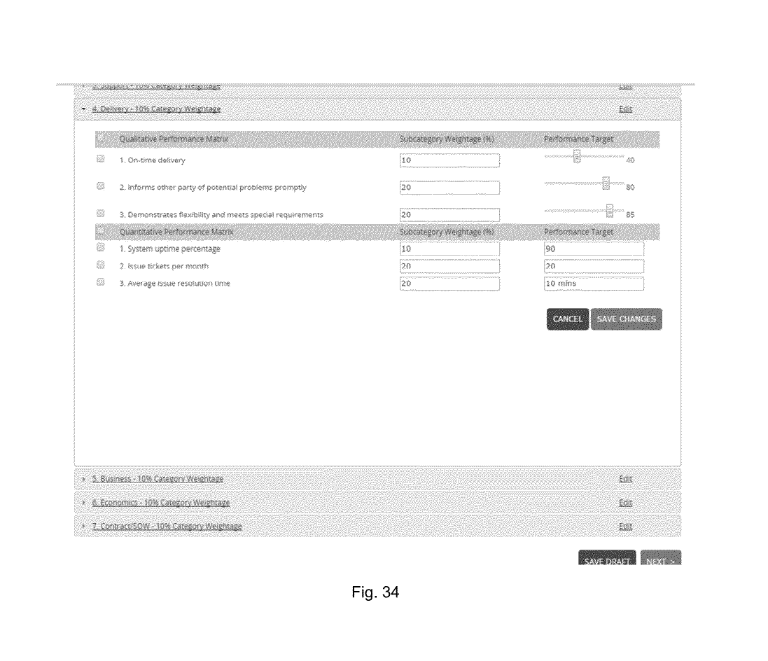

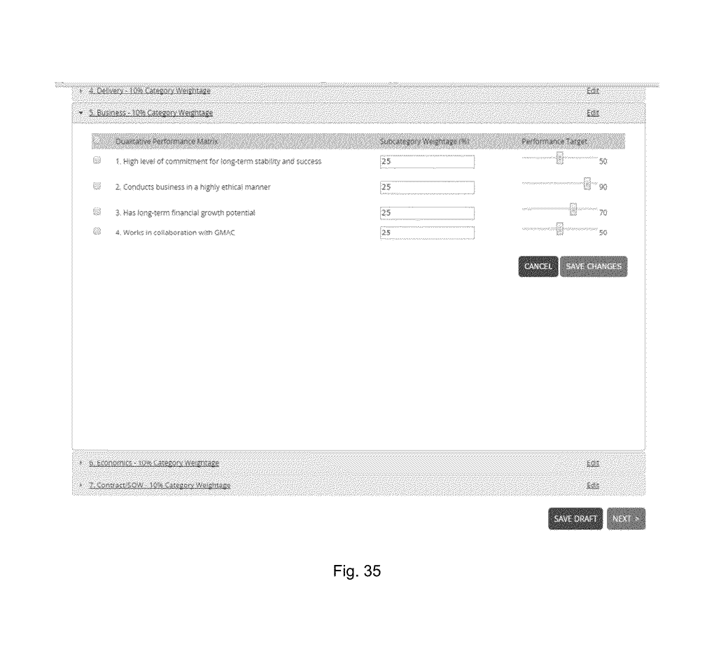

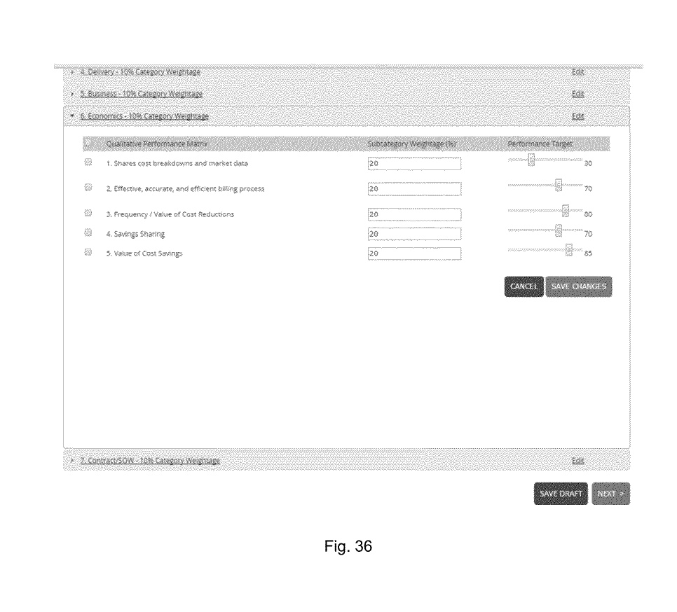

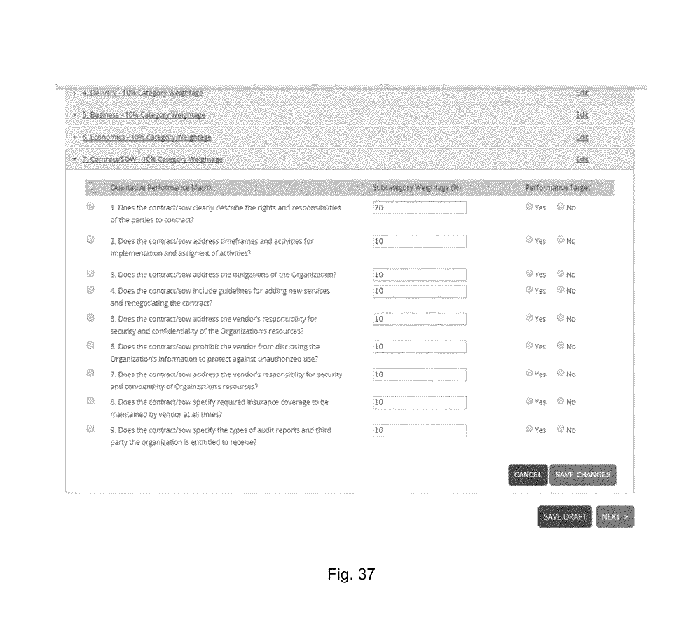

FIG. 30 through FIG. 37 present exemplary performance metric configurations for setting up a performance scorecard for a given vendor. Each metrics section is configurable to permit the input of comments for the overall area and for each specific metric. An overall comments space may be used to briefly summarize service provider's performance in each area. In each of these metric areas, a vendor manager may be given the flexibility to customize how the service provider is evaluated based on the performance attributes listed. In the given example, a vendor manager may include, exclude, and/or add new attributes in each of the six areas and determine the weight of each metric.

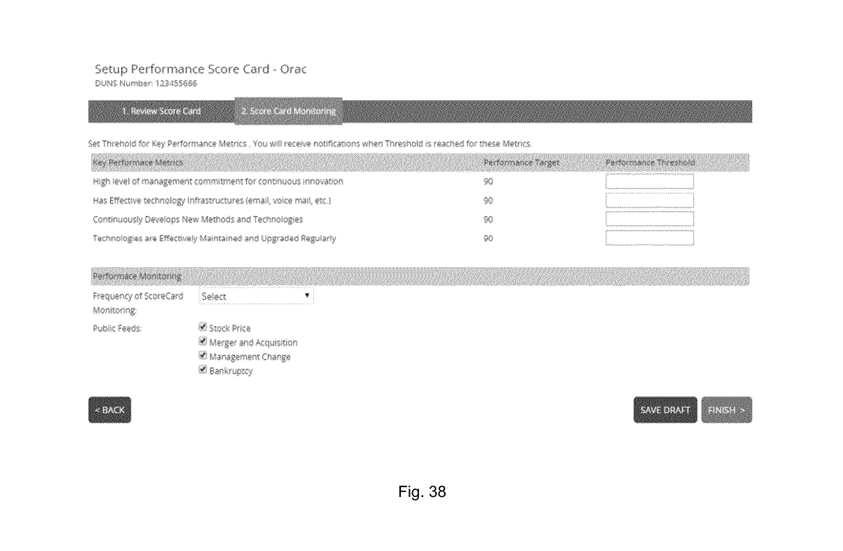

FIG. 38 presents configurations for thresholds of key performance metrics and performance monitoring associated with setting up a performance scorecard according to an embodiment of the present invention. Threshold performance metrics may be used as an early warning indication of a few select quantitative key performance indicators or metrics on the scorecard. Threshold levels may be selected for one or more of these metrics. If the threshold metric is broken (as a result from scorecarding), key employees such as the business unit vendor manager and the category manager may be notified via a dashboard notification or an electronic message. This indication helps organizations take corrective action with a service provider proactively. In the performance monitoring section, the frequency of scorecard monitoring (completion of scorecards) may be configured on a periodic basis such as weekly or monthly. Additionally, scorecard monitoring may include information from public feeds such as stock price, merger and acquisition, management change, and bankruptcy news.

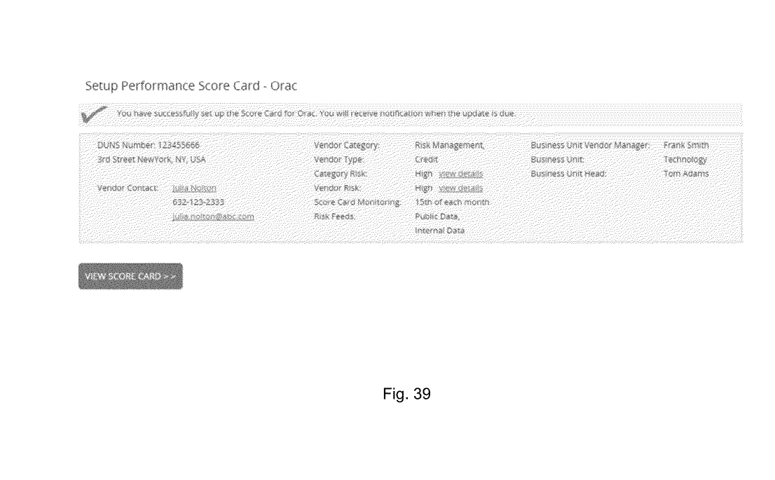

FIG. 39 presents a confirmation screen for successfully setting up a scorecard.

According to the illustrated embodiment, the vendor manager may receive notifications and/or reminders when an update is due (completion of scorecards).

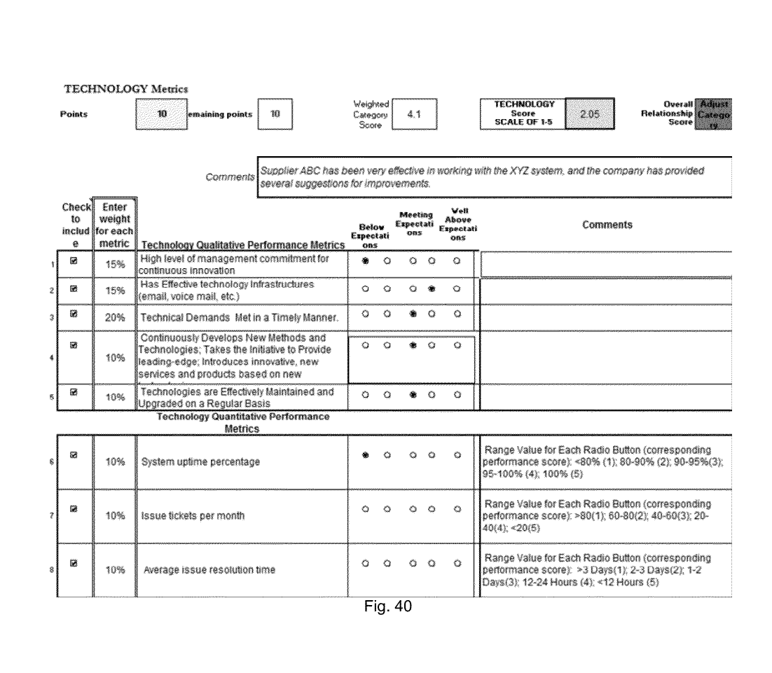

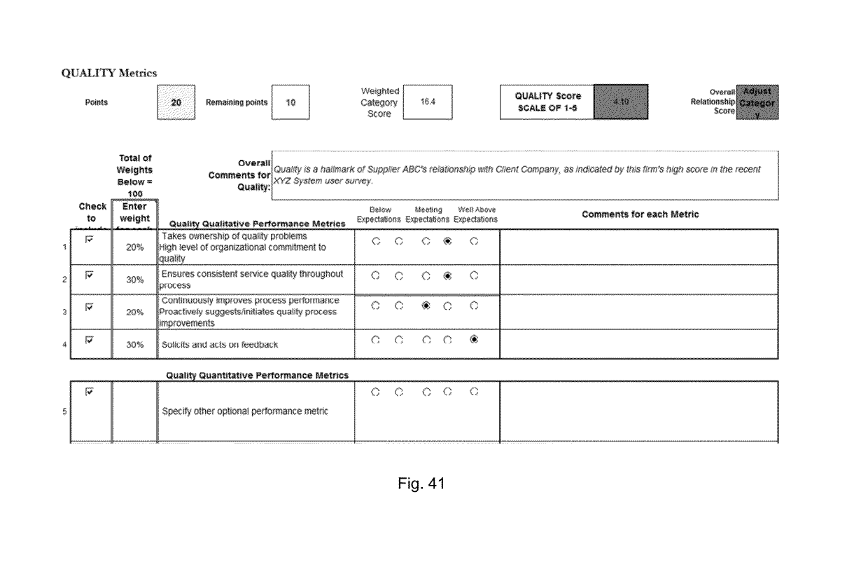

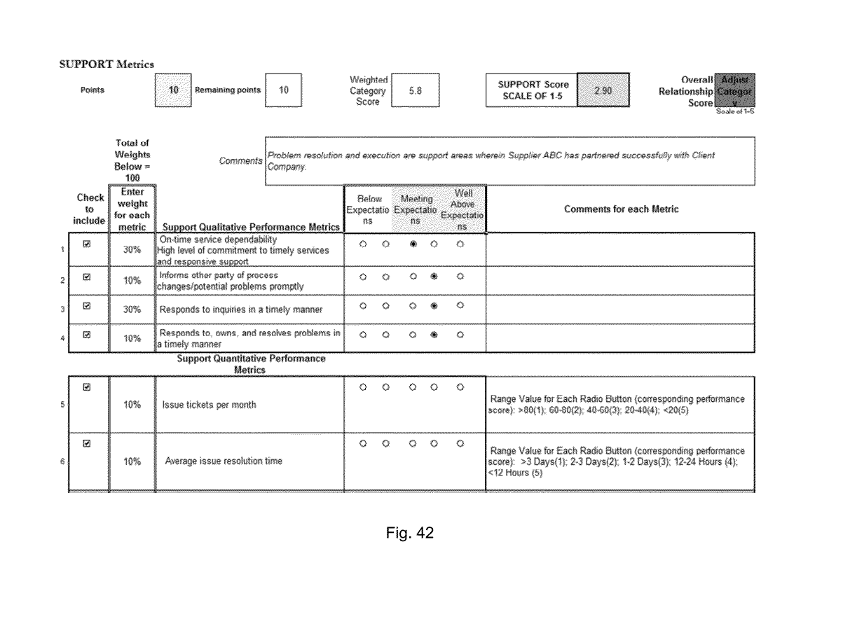

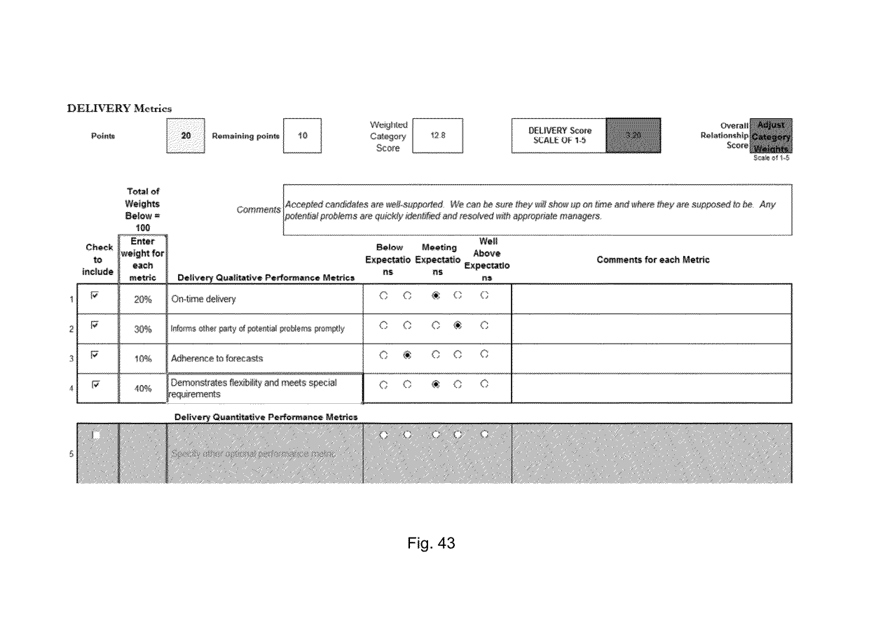

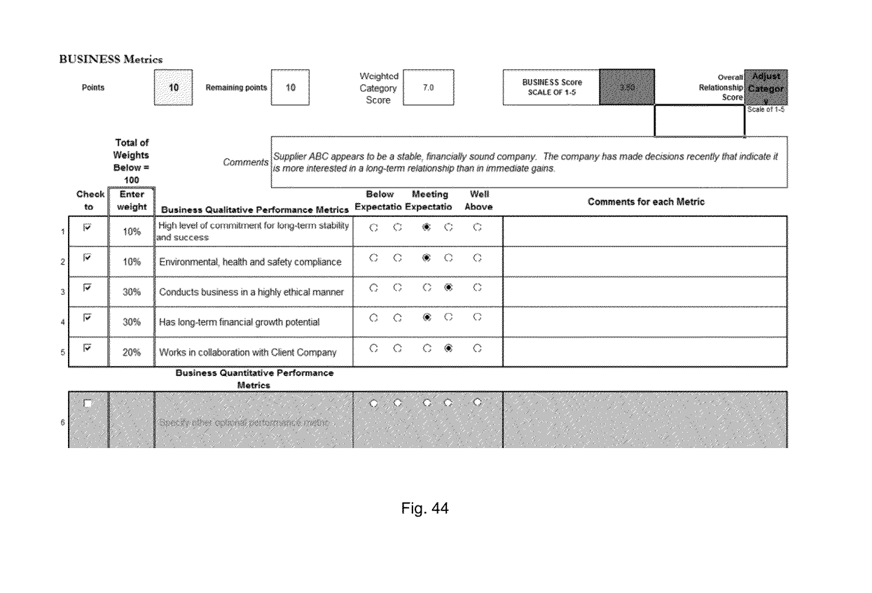

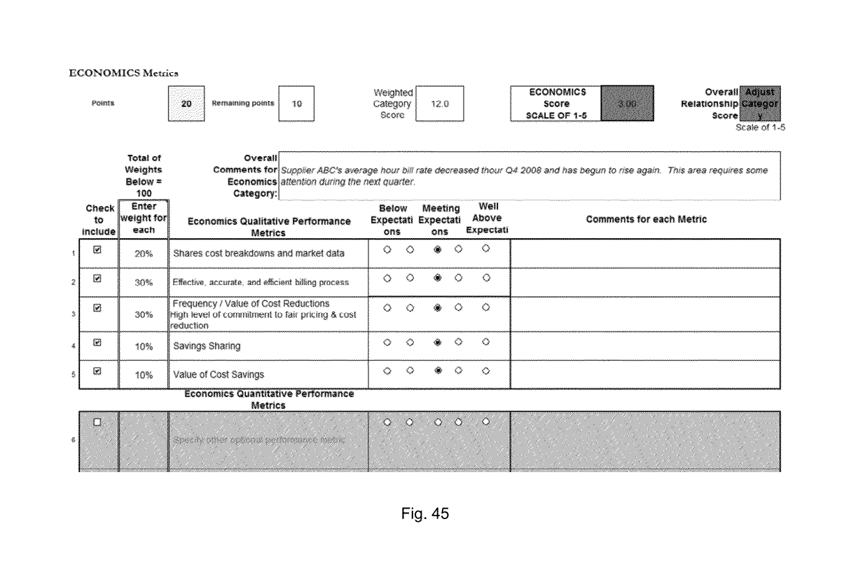

FIG. 40 through FIG. 45 present exemplary risk performance scorecards according to an embodiment of the present invention. A given performance criteria (e.g., technology, quality, support, delivery, business, economics) may be assigned a certain number of points and include certain performance metrics. The service provider can be rated by the vendor manager in each metric area by selecting an appropriate rating. For each metric, the vendor manager may provide a rating between, for example, “below expectations” and “well above expectations” that is scored on a scale e.g., from ‘1’ to ‘5’. Additionally, each metric may be assigned given a weighting.

According to one embodiment, each performance criteria includes a plurality of performance metrics. A performance criteria score is representative of an overall score of the performance metrics. The performance criteria score (on a scale of 1-5) may be calculated by

$$\frac{( weighted category score \times scale )}{points assigned to performance criteria} ,$$

wherein the weighted category score is equal to the sum of all weighted scores for all the performance metrics. A weighted score of a performance metric is calculated by

$$( points assigned to performance criteria \times performance metric weight ) \times ( \frac{score of performance metric}{scale} ) .$$

Overall risk performance score (of the scorecard) may be calculated by the total weighted performance score divided by 20, wherein total weighted performance score is equal to the sum of the weighted score of all performance metrics.

Where applicable, scorecard performance may be measured against a documented Service Level Agreements (SLAs) and contract terms. In these cases, meeting minimum SLA or contract requirements would earn a “Meeting Expectations” score. Otherwise, a vendor manager may assess how far below or above expectations to rate the service provider. For metrics where performance expectations are not documented, the vendor manager may consider whether the service provider's performance is meeting needs in those areas. Scorecards may be required to submitted or updated periodically (e.g., weekly or monthly), that is, on-going monitoring of service provider risk is performed to comply with corporate or regulatory policies. Underlying scorecard information (such as comments) can be fed into scorecard reports that may be viewed by, for example, by a business executive.

FIGS. 1 through 45 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A system for triaging and monitoring a risk source based on risk categorization, the system comprising:
a risk management server comprising:
a risk triage module configured to:
identify a risk source,
receive information associated with the risk source,
determine a category risk of the risk source,
probe an inherent risk of the risk source, and
configure scorecard monitoring for the risk source; and
a communications interface communicatively coupled to one or more client devices.

2. The system of claim 1 wherein the risk source originates from a service provider.

3. The system of claim 1 wherein the risk triage module is operable to determine the risk source has a category risk that is high.

4. The system of claim 1 wherein the risk triage module is operable to determine the risk source has an inherent risk that is high.

5. The system of claim 1 wherein the scorecard monitoring is configured for at least one of weekly and monthly monitoring.

6. The system of claim 1 wherein the risk triage module is operable to generate notification messages associated with the scorecard monitoring.
